(19) United States
(12) Patent Application Publication
(10) Pub. No.: US 2018/0065830 A1
(43) Pub. Date: Mar. 8, 2018

(54) ELEVATOR DOOR LOCK SAFETY DEVICE

(71) Applicant: Otis Elevator Company, Farmington, CT (US)

(72) Inventors: Loic Duchamp, Saint Martin d'Abbat (FR); Sebastien Fougeron, Lorris (FR); Arnaud Blanchard, Nogent sur Vernisson (FR)

(21) Appl. No.: 15/687,654

(22) Filed: Aug. 28, 2017

(30) Foreign Application Priority Data
Sep. 8, 2016 (EP) 16306123.7

(51) Int. Cl. B66B 5/00; E05C 19/18

(52) U.S. Cl. CPC B66B 5/005; E05Y 2900/104; E05C 19/184

(57) ABSTRACT

Elevator door lock safety devices including a base, a first expanding extension member extending from the base, the first expanding extension member having a first exterior surface and a first interior surface, a second expanding extension member extending from the base and opposing the first expanding extension member, the second expanding extension member having a second exterior surface and a second interior surface, wherein a separation distance is defined between the first and second interior surfaces, an actuator aperture formed within the first expanding extension member and extending through the first expanding extension member from the first exterior surface to the first interior surface, and an actuation device passing through the actuator aperture, wherein actuation of the actuation device actuates the elevator door lock safety device from a first state to a second state, wherein the separation distance is greater in the second state than in the first state.

### CROSS-REFERENCE TO RELATED APPLICATIONS

This application claims the benefit of European Application No. 16306123.7 filed Sep. 8, 2016, which is incorporated herein by reference in its entirety.

### BACKGROUND

The subject matter disclosed herein generally relates to elevator systems and, more particularly, to elevator door lock safety devices.

Elevator systems include locking mechanisms that are useable by mechanics, technicians, and other authorized persons. The locking mechanisms can be part of lintels of the elevator systems and thus may be easily accessible by anyone. However, it may be required by safety regulations and/or advantageous to prevent access to and/or operation of the elevator locking mechanisms at certain times (e.g., when a technician or mechanic is performing a maintenance operation). Accordingly, safety devices that prevent access to the elevator system locking mechanisms may be desirable.

### SUMMARY

According to one embodiment, elevator door lock safety devices are provided. The elevator door lock safety devices include a base, a first expanding extension member extending from the base, the first expanding extension member having a first exterior surface and a first interior surface, a second expanding extension member extending from the base and opposing the first expanding extension member, the second expanding extension member having a second exterior surface and a second interior surface, wherein a separation distance is defined between the first and second interior surfaces, an actuator aperture formed within the first expanding extension member and extending through the first expanding extension member from the first exterior surface to the first interior surface, and an actuation device passing through the actuator aperture, wherein actuation of the actuation device actuates the elevator door lock safety device from a first state to a second state, wherein the separation distance is greater in the second state than in the first state.

In addition to one or more of the features described above, or as an alternative, further embodiments of the elevator door lock safety device may include a friction member located on each of the first and second expanding extension members, wherein the friction member is configured to provide friction engagement with an engagement surface of a door lock.

In addition to one or more of the features described above, or as an alternative, further embodiments of the elevator door lock safety device may include that the friction member comprises an elastic ring.

In addition to one or more of the features described above, or as an alternative, further embodiments of the elevator door lock safety device may include that at least one of the first expanding extension member and the second expanding extension member includes a friction member recess and the friction member fits within the friction member recess.

In addition to one or more of the features described above, or as an alternative, further embodiments of the elevator door lock safety device may include that the friction member comprises a textured surface on the exterior surface of at least one of the first expanding extension member and the second expanding extension member.

In addition to one or more of the features described above, or as an alternative, further embodiments of the elevator door lock safety device may include at least one plate receiving recess formed in the base and a securing plate removably receivable in the at least one plate receiving recess of the base, wherein when the securing plate is secured to the base access to the actuation device is prevented.

In addition to one or more of the features described above, or as an alternative, further embodiments of the elevator door lock safety device may include that the securing plate includes a through-hole and a track, wherein the through-hole has a dimension greater than the base such that the base can pass therethrough, and the track has a lesser dimension than the through-hole such that the securing plate can engage with the at least one plate receiving recess.

In addition to one or more of the features described above, or as an alternative, further embodiments of the elevator door lock safety device may include a locking device, wherein the locking device is configured to secure the securing plate to the base such that the securing plate cannot be removed therefrom when the locking device is installed.

In addition to one or more of the features described above, or as an alternative, further embodiments of the elevator door lock safety device may include that the actuation device comprises a threaded bolt and the actuator aperture is a threaded hole.

In addition to one or more of the features described above, or as an alternative, further embodiments of the elevator door lock safety device may include that the actuation device comprises a lever arm, pivot, and a shaft.

Technical effects of embodiments of the present disclosure include an elevator door lock safety device that can be inserted into a door lock of an elevator system to prevent unauthorized access to the door lock.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the present disclosure;

FIG. 2 is a schematic illustration of a landing floor of an elevator system with a hall call panel that may employ various embodiments of the present disclosure;

FIG. 3A is a schematic illustration of an elevator door lock safety device in accordance with an embodiment of the present disclosure;

FIG. 3B is a schematic illustration of the elevator door lock safety device of FIG. 3A as inserted into an elevator door lock;

FIG. 4A is a front side elevation illustration of an elevator door lock safety device in accordance with an embodiment of the present disclosure;

FIG. 4B is a left side elevation illustration of the elevator door lock safety device of FIG. 4A;

FIG. 4C is a cross-section schematic illustration of the elevator door lock safety device of FIG. 4A in a first state as viewed along the line A-A of FIG. 4B;

FIG. 4D is a cross-section schematic illustration of the elevator door lock safety device of FIG. 4A in a second state as viewed along the line A-A of FIG. 4B;

FIG. 5A is an enlarged illustration of an elevator door lock safety device as inserted into a door lock in a first state;

FIG. 5B is an illustration of the elevator door lock safety device of FIG. 5A in a second state;

FIG. 6 is an illustration of an elevator door lock safety device in accordance with an embodiment of the present disclosure having an optional securing plate;

FIG. 7 is an illustration of an elevator door lock safety device in accordance with an embodiment of the present disclosure having an optional locking device;

FIG. 8 is a flow process for installing an elevator door lock safety device into a door lock in accordance with an embodiment of the present disclosure; and

FIG. 9 is a cross-section illustration of an elevator door lock safety device in accordance with an embodiment of the present disclosure having an example alternative configuration of an actuation device.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

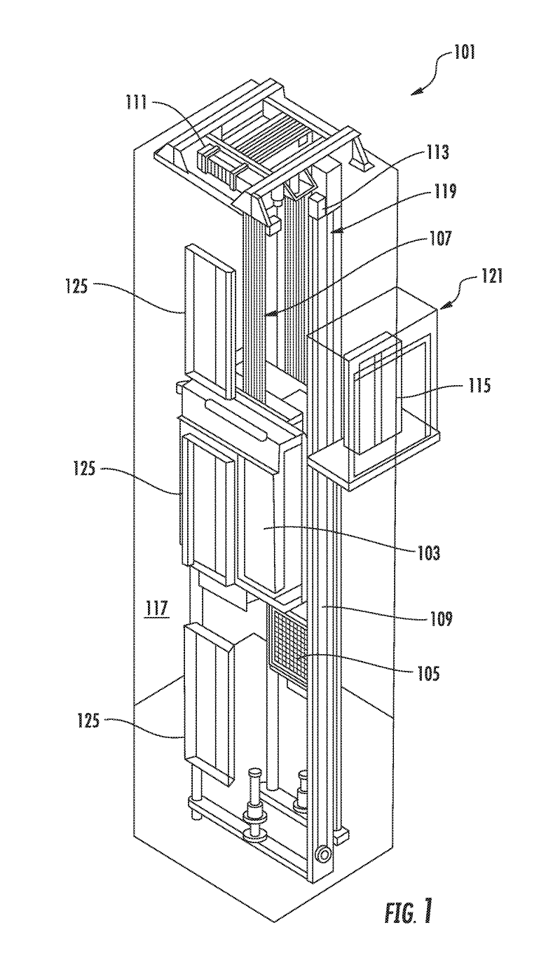

FIG. 1 is a perspective view of an elevator system 101 including an elevator car 103, a counterweight 105, a roping 107, a guide rail 109, a machine 111, a position encoder 113, and an elevator controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The elevator controller 115 is located, as shown, in a controller room 121 of the elevator shaft 117 and is configured to control the operation of the elevator system 101, and particularly the elevator car 103. For example, the elevator controller 115 may provide drive signals to the machine 111 to control the acceleration, deceleration, leveling, stopping, etc. of the elevator car 103. The elevator controller 115 may also be configured to receive position signals from the position encoder 113. When moving up or down within the elevator shaft 117 along guide rail 109, the elevator car 103 may stop at one or more landings 125 as controlled by the elevator controller 115. Although shown in a controller room 121, those of skill in the art will appreciate that the elevator controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes.

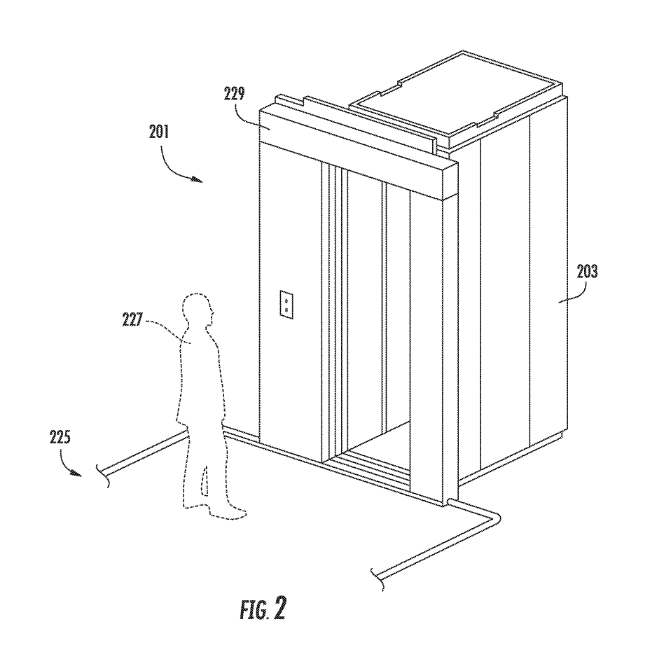

FIG. 2 is a schematic illustration of an elevator system 201 that may incorporate embodiments disclosed herein. As shown in FIG. 2, an elevator car 203 is located at a landing 225. The elevator car 203 may be called to the landing 225 by a passenger or mechanic 227 that desires to travel to another floor within a building or perform maintenance on the elevator system 201. In some situations, the mechanic 227 may wish to lock the elevator doors such that they cannot be opened or closed (e.g., to prevent unauthorized persons from accessing the elevator system 201). For example, such situation may arise when the mechanic 227 wishes to enter the elevator pit to perform maintenance therein. Such control or locking can be achieved by a door lock hole in a lintel 229 of the elevator system 201 (which may be located at each landing 225). It may be advantageous to prevent unauthorized persons from accessing the elevator door lock. Accordingly, embodiments provided herein are directed to an elevator door lock safety device that securely prevents unauthorized access to the elevator door lock.

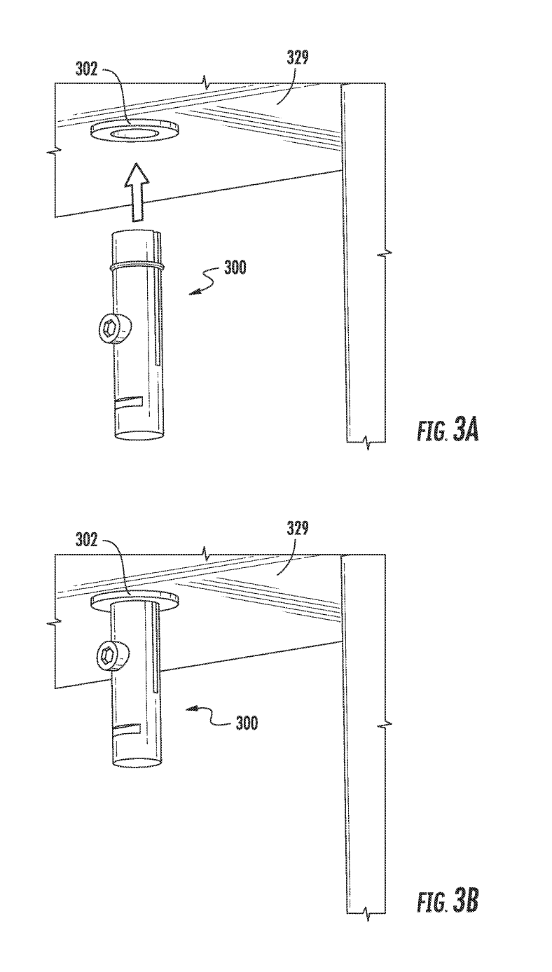

Turning to FIGS. 3A-3B, an elevator door lock safety device 300 in accordance with an embodiment of the present disclosure is shown. The elevator door lock safety device 300 is configured to fit within an aperture of a door lock 302 of a lintel 329. The elevator door lock safety device 300 is configured to fit within the door lock 302 and securely be retained therein such that a person cannot remove the elevator door lock safety device 300 from the lintel 329. Accordingly, a mechanic can safely secure the door lock 302 and perform a maintenance operation without worry that the elevator doors and/or elevator system will be improperly operated. For example, FIG. 3B schematically illustrates the elevator door lock safety device 300 as inserted into the door lock 302 and thus preventing or blocking access to the door lock 302.

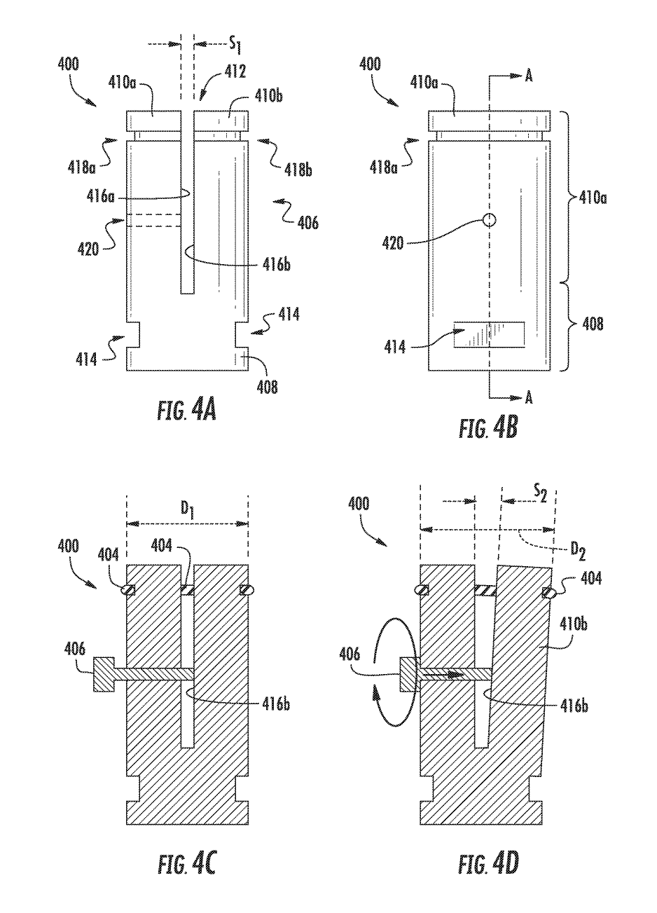

Turning now to FIGS. 4A-4D, operation of an elevator door lock safety device 400 in accordance with an embodiment of the present disclosure is schematically shown. The elevator door lock safety device 400 is similar to that described above with respect to FIGS. 3A-3B and is designed and configured to fit within an aperture of an elevator door lock and provide unauthorized access thereto. FIG. 4A is a front side elevation illustration of the elevator door lock safety device 400. FIG. 4B is a left side elevation illustration of the elevator door lock safety device 400. FIG. 4C is a cross-section illustration of the elevator door lock safety device 400 in a first state and having an optional friction member 404 and an actuation device 406 installed therewith as viewed along the line A-A in FIG. 4B. FIG. 4D is a cross-section illustration of the elevator door lock safety device 400 in a second state that is achieved by actuation of the actuation device 406.

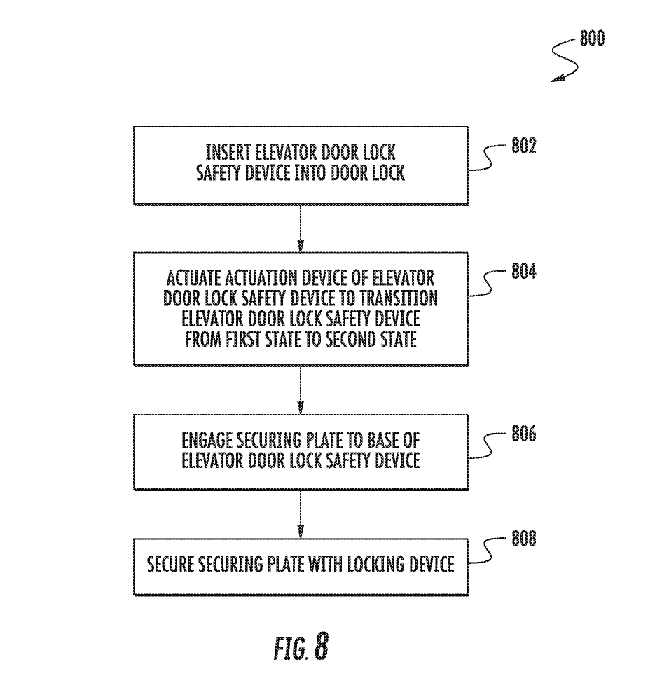

Referring to FIG. 4A, the elevator door lock safety device 400 includes a base 408 having a first expanding extension member 410a and a second expanding extension member 410b extending therefrom. The base 408 may have a circular or cylindrical shape, and each of the expanding extension members 410a, 410b can comprise a portion of a circle or cylinder. That is, a separation distance 412 is defined between the first and second expanding extension members 410a, 410b. The base 408 includes a plate receiving recess 414, which can be circular (e.g., extend around the circumference of the base 408) or may be formed from one or more recesses (e.g., as schematically shown in FIGS. 3A-3B). The plate receiving recess 414 can be configured to receive a plate as described herein (e.g., as shown in FIGS. 6-7).

Each of the first expanding extension member 410a and the second expanding extension member 410b include a respective interior surface, with the first expanding extension member 410a having a first interior surface 416a and the second expanding extension member 410b having a second interior surface 416b that opposes the first interior surface 416a. The separation distance 412 is defined between the opposing first and second interior surfaces 416a, 416b. Further, each expanding extension member 410a, 410b includes a respective friction member recess 418a, 418b that is configured to receive a portion of the friction member 404 (as shown in FIG. 4B).

Further, as shown in FIG. 4A, the first expanding extension member 410a includes an actuator aperture 420. The actuator aperture 420 is sized and shaped to receive the actuation device 406. In some embodiments, the actuator aperture 420 can be threaded and enable a threaded (and movable) connection between the first expanding extension member 410a and the actuation device 406 (e.g., a threaded hole and bolt interaction). That is, the actuation device 406 can be moved through the actuator aperture 420 toward or away from the second interior surface 416b of the second expanding extension member 410b.

FIGS. 4A-4B illustrate the elevator door lock safety device 400 in a first state. In some embodiments, the first and second expanding extension members 410a, 410b can be biased toward the first state such that the actuation device 406 is required to move the expanding extension members 410a, 410b toward the second state shown in FIG. 4C. In the first state, the separation distance 412 has a first separation distance S₁, that is, the first interior surface 416a is separated from the second interior surface 416b by the first separation distance S₁. Further, in the first state, as shown in FIG. 4B, the elevator door lock safety device 400 has a first diameter D₁. The first diameter D₁ is selected to be less than an aperture, opening or hole of an elevator door lock such that the elevator door lock safety device 400 can easily fit therein.

As noted, the second state of the elevator door lock safety device 400 is shown in FIG. 4C. In the second state, the actuation device 406 is actuated such that it translates within the actuator aperture 420 through the first expanding extension member 410a toward the second expanding extension member 410b. As the actuation device 406 is actuated, the actuation device 406 contacts and applies force upon the second expanding extension member 410b. Accordingly, the second expanding extension member 410b is moved relatively away from the first expanding extension member 410a and the separation distance 412 is increased. For example, as shown, the separation distance 412 is expanded to a second separation distance S₂ and the elevator door lock safety device 400 has a second diameter D₂. As will be appreciated by those of skill in the art, the second separation distance S₂ and the second diameter D₂ are greater than the first separation distance S₁ and the first diameter D₁. The second diameter D₂ is selected or predefined to be greater than the opening or hole of the elevator door lock aperture such that the elevator door lock safety device 400 cannot easily be removed therefrom. That is, in the second state, the elevator door lock safety device 400 forms an interference or friction fit with the elevator door lock.

The friction member 404 can be an optional feature that increases friction between the elevator door lock safety device 400 and the elevator door lock. For example, the friction member 404 can be an elastic member (e.g., rubber or composite O-ring) that fits with the friction member recesses 418a, 418b. The elasticity of the friction member 404 enables the friction member 404 to stretch or expand during actuation from the first state to the second state of the elevator door lock safety device 400. That is, the friction member 404 is selected to accommodate the increased separation of the first and second expanding extension member members 410a, 410b.

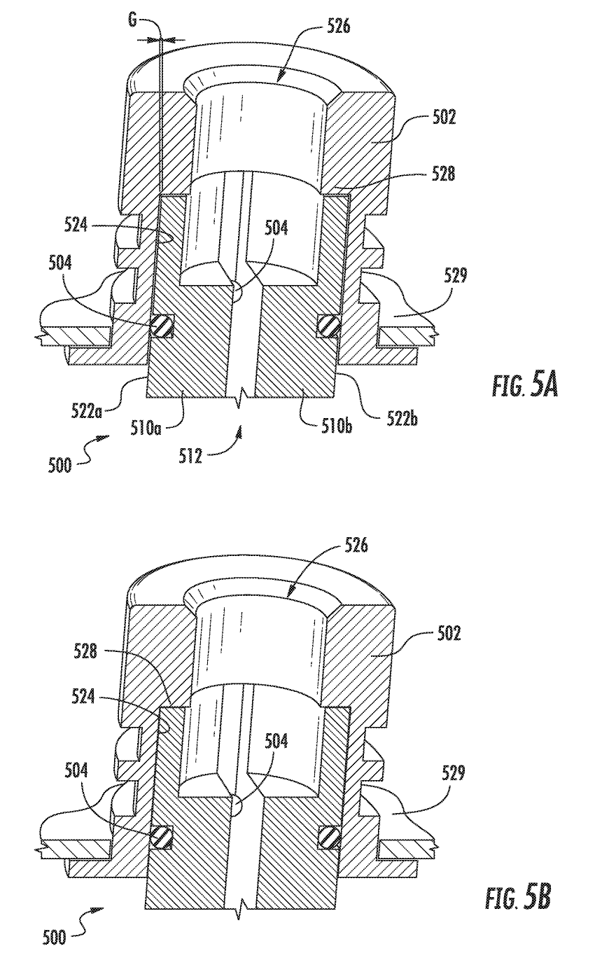

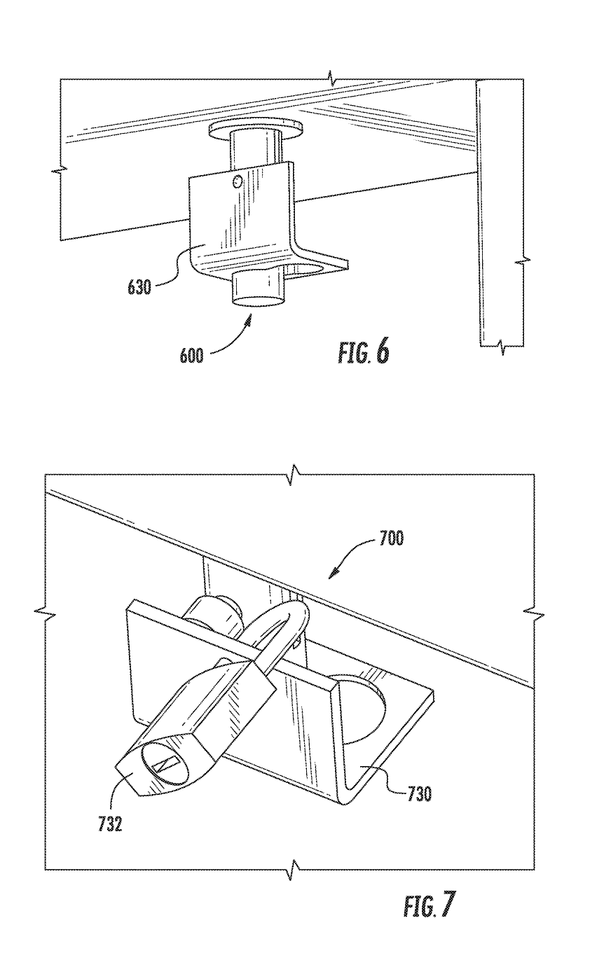

Turning now to FIGS. 5A-5B, enlarged schematic illustrations of the interaction of an elevator door lock safety device 500 and a door lock 502 in accordance with an embodiment of the present disclosure are shown. The elevator door lock safety device 500 may be similar to that shown and described above. Accordingly, the elevator door lock safety device 500 includes a base with a first expanding extension member 510a and a second expanding extension member 510b. The first and second expanding extension members 510a, 510b have interior surfaces that oppose each other and define a separation distance 512, as described above. Further, each of the expanding extension members 510a, 510b has a respective exterior surface 522a, 522b.

As shown in FIG. 5A, the door lock 502 includes an engagement surface 524 that receives and engages with the elevator door lock safety device 500 in the second state. The engagement surface 524 defines at least a portion of a door lock aperture 526. The engagement surface 524 includes a shoulder 528. The expanding extension members 510a, 510b can abut or contact the shoulder 528 such that when inserted a technician or mechanic can know that the elevator door lock safety device 500 is properly inserted into the aperture 526.

FIG. 5A illustrates the first state wherein the elevator door lock safety device 500 is inserted into the door lock 502 but not engaged therewith. As shown in FIG. 5A, when the elevator door lock safety device 500 is in the first state, an exterior gap G exists. That is, the exterior surfaces 522a, 522b of the expanding extension members 510a, 510b do not contact the engagement surface 524 of the door lock 502. In the first state, an optional friction member 504 may or may not contact the engagement surface 524 and does not substantially interfere with a mechanic's ability to insert the elevator door lock safety device 500 into the door lock 502.

As shown in FIG. 5B, the elevator door lock safety device 500 is shown in the second state. In the second state, the actuation device (described above) is actuated and the expanding extension members 510a, 510b are moved apart, thus widening the separation distance 512. As the expanding extension members 510a, 510b separate during actuation of the actuation device, the exterior surfaces 522a, 522b will contact the engagement surface 524 of the door lock 502. The exterior surfaces 522a, 522b will engage with the engagement surface 524 and form an interference or friction fit. The interference or friction fit of the elevator door lock safety device 500 with the door lock 502 will prevent unauthorized persons from accessing the elevator door lock 502.

Further, as shown in FIG. 5B, the optional friction member 504 can be engaged with the engagement surface 524 when the elevator door lock safety device 500 is in the second state. The friction member 504 can generate additional friction contact between the elevator door lock safety device 500 and the engagement surface 524, and thus further improve a securing force to prevent removal of the elevator door lock safety device 500 from the door lock 502. The actuation device can be reversed to reduce the separation distance 512 and thus reduce the friction contact between the elevator door lock safety device 500 and the engagement surface 524, thus enabling removal of the elevator door lock safety device 500 from the door lock 502 when a technician or mechanic has completed a maintenance operation or for other reason.

Turning now to FIG. 6, a non-limiting embodiment of an elevator door lock safety device 600 in accordance with the present disclosure is shown. In the embodiment of FIG. 6, the elevator door lock safety device 600 is substantially similar to that shown and described above and operates in a similar manner. Additionally, as shown, the elevator door lock safety device 600 includes a securing plate 630. The securing plate 630 can be removably attached or connected to the base of the elevator door lock safety device 600, and in some embodiments can slide onto and engage with the base of the elevator door lock safety device 600 with the plate receiving recesses of the elevator door lock safety device 600 (e.g., as shown in FIGS. 3A-4C).

The securing plate 630 can include a through-hole and track to receive and securely attach to the elevator door lock safety device 600. For example, the through-hole can have a diameter that is greater than a diameter of the base of the elevator door lock safety device 600 such that the base can pass through the through-hole and the plate receiving recesses can align with the track of the securing plate 630. The securing plate 630 can then slideably engage with the base at the plate receiving recesses such that the securing plate 630 is fixed to or retained on the elevator door lock safety device 600.

The securing plate 630 is designed and shaped to cover the actuation device of the elevator door lock safety device 600. That is, when the securing plate 630 is installed to the base of the elevator door lock safety device 600, access to the actuation device is prevented (e.g., compare FIG. 3B and FIG. 6).

Turning now to FIG. 7, another non-limiting embodiment of the present disclosure is shown. FIG. 7 illustrates an elevator door lock safety device 700 with a securing plate 730 installed onto the base of the elevator door lock safety device 700. Further, as shown, an optional locking device 732 is used to secure the securing plate 730. The locking device 732 prevents the securing plate 730 from moving and/or being removed from the elevator door lock safety device 700. Accordingly, the locking device 732 provides additional security and prevention of access to the elevator lock.

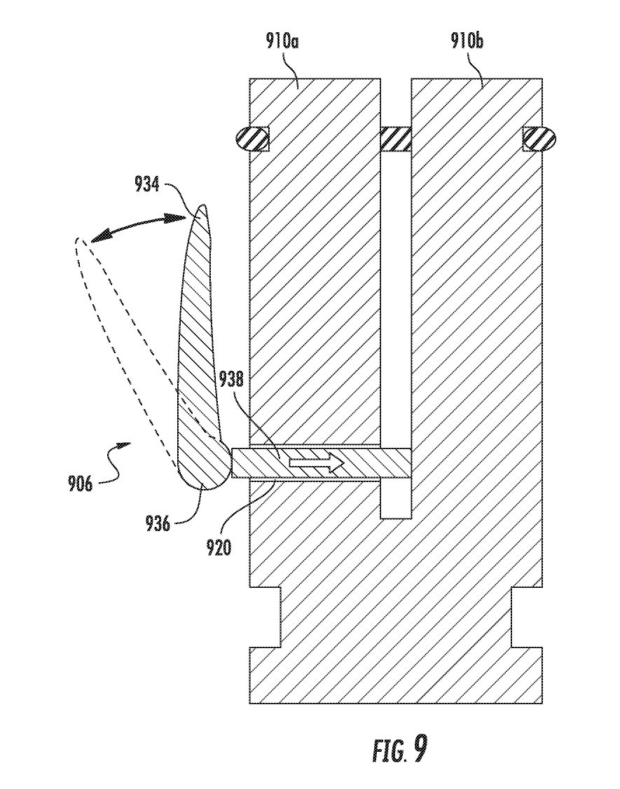

Turning now to FIG. 8, a flow process for using elevator door lock safety devices of the present disclosure is shown. The flow process 800 can be performed using an elevator door lock safety device of any of the above embodiments and/or variations thereon, and thus the flow process is not to be limited to only the above shown and described devices.

At block 802, the elevator door lock safety device is inserted into an aperture of the door lock of the elevator system. The elevator door lock safety device can be inserted until the elevator door lock safety device contacts or is stopped by a shoulder that is within the aperture of the door lock.

At block 804 an actuation device of the elevator door lock safety device is actuated to transition the elevator door lock safety device from a first state to a second state. The second state can be a state wherein the elevator door lock safety device is fixedly secured or engaged within the door lock such that access to the door lock is prevented. The actuation device can increase a separation of opposing expanding extension members of the elevator door lock safety device such that the elevator door lock safety device forms a friction or interference fit with an engagement surface of the door lock.

In some non-limiting embodiments, the actuation of the actuation device can include tightening a screw or bolt such that a portion of the actuation device applies a force to one of two expanding extension members. In other embodiments, other actuation actions can be taken without departing from the scope of the present disclosure.

As the actuation device is actuated, the more the separation of the two opposing expanding extension members increases. For example, a gap that is formed between an exterior surface of the elevator door lock safety device and an engagement surface of the door lock can be reduced from, for example, 0.2 mm to 0.0 mm (e.g., contact). Further, if an optional friction member is provided (and it is an elastic member), an area of the friction member can be increased with the increase in horizontal load (e.g., compression between the expanding extension members and the engagement surface) and thus an increase in friction will result, thus making removal of the elevator door lock safety device from the door lock more difficult.

At block 806, a securing plate is engaged to a base of the elevator door lock safety device to protect and prevent access to the actuation device.

At block 808, a locking device is used to secure the securing plate such that the securing plate cannot be moved, translated, and/or removed from the base of the elevator door lock safety device.

The reverse flow process can be used to remove the elevator door lock safety device from the door lock.

Turning now to FIG. 9, a non-limiting variation of an elevator door lock safety device in accordance with the present disclosure is shown. FIG. 9 is a cross-section illustration view similar to that shown in FIGS. 4B-4C. In FIG. 9, an elevator door lock safety device 900 similar to that shown and described above is shown. In the embodiment of FIG. 9, however, an actuation device 906 is configured differently than that described above. In this embodiment, the actuation device 906 includes a lever arm 934, a pivot 936, and a shaft 938. As shown by the dashed line representation of the lever arm 934, a technician can pull the lever arm 934 outward from (or push it inward toward) a first expanding extension member 910a. The lever arm 934 will act upon the shaft 938 to move the shaft 938 through an actuator aperture 920 and thus apply force to a second expanding extension member 910b (similar to that described above). The embodiment of FIG. 9 is provided as an example alternative configuration and is not intended to be limiting, and those of skill in the art will appreciate that the various features and components of the elevator door lock safety device of the present disclosure can take various forms without departing from the scope of the present disclosure.

Advantageously, embodiments provided herein enable a secure and safe mechanism for securing an elevator door lock, thus preventing unauthorized access to the door lock. Further, advantageously, because the operation of the elevator door lock safety devices provided herein merely requires actuation of a device to separate two extending members, the elevator door lock safety devices of the present disclosure can be used in various diameter holes of door locks. That is, in some respects, the elevator door lock safety devices of the present disclosure are relatively universal and not specific to any particular door lock size.

The use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

For example, although illustrated as a screw bolt or lever action, the actuation device of the elevator door lock safety device of the present disclosure can take other forms. Additionally, various features shown and described herein can be optional and/or varied without departing from the scope of the present disclosure. For example, although described above as a separate component, the friction member can be integrally formed with or part of the expanding extension members. In some embodiments, the friction member can be a textured surface that can provide additional friction or gripping between the expanding extension members and the engagement surface of the door lock. Further, in some embodiments, rather than an O-ring configuration (as shown), the friction member can be a sleeve made from a selected material that provides similar characteristics as the above described ring structure (e.g., elasticity, friction enhancement, etc.).

Furthermore, for example, although shown and described as a cylinder, the elevator door lock safety devices of the present disclosure can take any geometric shape, including, but not limited to, squares, hexagons, octagons, etc.

Accordingly, the present disclosure is not to be seen as limited by the foregoing description, but is only limited by the scope of the appended claims.

What is claimed is:

1. An elevator door lock safety device comprising:
a base;
a first expanding extension member extending from the base, the first expanding extension member having a first exterior surface and a first interior surface;
a second expanding extension member extending from the base and opposing the first expanding extension member, the second expanding extension member having a second exterior surface and a second interior surface, wherein a separation distance is defined between the first and second interior surfaces;
an actuator aperture formed within the first expanding extension member and extending through the first expanding extension member from the first exterior surface to the first interior surface; and
an actuation device passing through the actuator aperture, wherein actuation of the actuation device actuates the elevator door lock safety device from a first state to a second state, wherein the separation distance is greater in the second state than in the first state.

2. The elevator door lock safety device of claim 1, further comprising a friction member located on each of the first and second expanding extension members, wherein the friction member is configured to provide friction engagement with an engagement surface of a door lock.

3. The elevator door lock safety device of claim 2, wherein the friction member comprises an elastic ring.

4. The elevator door lock safety device of claim 2, wherein at least one of the first expanding extension member and the second expanding extension member includes a friction member recess and the friction member fits within the friction member recess.

5. The elevator door lock safety device claim 2, wherein the friction member comprises a textured surface on the exterior surface of at least one of the first expanding extension member and the second expanding extension member.

6. The elevator door lock safety device of claim 1, further comprising:
at least one plate receiving recess formed in the base; and
a securing plate removably receivable in the at least one plate receiving recess of the base, wherein when the securing plate is secured to the base access to the actuation device is prevented.

7. The elevator door lock safety device of claim 6, wherein the securing plate includes a through-hole and a track, wherein the through-hole has a dimension greater than the base such that the base can pass therethrough, and the track has a lesser dimension than the through-hole such that the securing plate can engage with the at least one plate receiving recess.

8. The elevator door lock safety device of claim 6, further comprising a locking device, wherein the locking device is configured to secure the securing plate to the base such that the securing plate cannot be removed therefrom when the locking device is installed.

9. The elevator door lock safety device of claim 1, wherein the actuation device comprises a threaded bolt and the actuator aperture is a threaded hole.

10. The elevator door lock safety device of claim 1, wherein the actuation device comprises a lever arm, pivot, and a shaft.
